(19) United States
(12) Patent Application Publication
(10) Pub. No.: US 2022/0180726 A1
(43) Pub. Date: Jun. 9, 2022

(54) Vehicle Safety Systems and Methods

(71) Applicant: Lee Bender, Huntsville, AL (US)

(72) Inventor: Lee Bender, Huntsville, AL (US)

(21) Appl. No.: 17/409,197

(22) Filed: Aug. 23, 2021

Related U.S. Application Data
(60) Provisional application No. 63/122,093, filed on Dec. 7, 2020.

(51) Int. Cl. G08B 21/24; B60R 25/102; G07C 5/00; G07C 5/08; B60N 2/00; G08B 7/06

(52) U.S. Cl. CPC G08B 21/24; B60R 25/102; G08B 7/06; G07C 5/0808; B60N 2/002; G07C 5/008

(57) ABSTRACT

The present disclosure is an electronic device that senses when the ignition of a vehicle has been turned off and automatically delivers a reminder, audibly, visibly, haptically or through other electronic means, to remind the driver to check the interior for any young passengers, pets, or valuables before exiting the vehicle. After this message is delivered, the device will continue to actively monitor the interior of the vehicle for both extreme compartment temperatures and any activity that indicates that a person or animal is still present inside of the vehicle. It will also sense any case where an individual has entered the vehicle unattended without the operator's knowledge and the vehicle is not started within a reasonable amount of time as expected. Once a determination for either of these situations has been made, an alert is delivered electronically to the vehicle owner or any other relevant parties in the vicinity. If no response or corrective action is taken by the recipients of these alerts after a second alert is provided, emergency services or a third-party monitoring service is contacted, via an integrated cellular device, to report the status of the vehicle to emergency services for assistance or intervention. The device will continue to stay in this “alert” mode until the vehicle ignition is activated by the operator. Operation of the vehicle or a direct connection with ignition switched voltage provides the power that to keep the battery of the device charged when the vehicle is not in use.

### CROSS-REFERENCE TO RELATED APPLICATION

This application claims priority to U.S. Provisional Patent Application Ser. No. 63/122,093 entitled Automotive Safety Devices and Methods for Children and Pets and filed on Dec. 7, 2020, which is incorporated herein by reference.

### BACKGROUND

In recent years, the number of “hot car” deaths experienced by parents or care givers who have accidentally left children in vehicles has received a lot of attention. In 2018 alone, there were 52 reported cases of children dying in the United States after being left in a hot vehicle unattended. One reason for this is because the body of a child heats up three to five times faster than an adult, making them more likely to suffer death from being left alone in a hot vehicle. Heat stroke is second largest cause of death for children under 14, with car crashes being the number one cause. This means that the top two causes of death among children under 14 are affiliated with automotive related accidents.

When a person is left inside of a vehicle without the benefit of air conditioning, the interior temperature increases rapidly, particularly in the warmer months of the year. If the core temperature of an individual reaches 104 degrees, it is possible that they will suffer from heatstroke. A core temperature of 108 degrees significantly increases the chances of permanent brain damage. In a study of 800 different hot car deaths from 1998-2018, 26.3% of them were cases where a child gained access to a vehicle on their own and became trapped. In 0.9% of the incidents, children were found dead without anyone knowing how they managed entry into the vehicle. The statistical number of hot car deaths for pets documented is similar in overall numbers as children, although it is quite likely that many of them go unreported.

### BRIEF DESCRIPTION OF THE DRAWINGS

The present disclosure can be better understood referencing the following drawings. The elements of the drawings are not necessarily to scale relative to each other, emphasis instead placed upon clearly illustrating the principles of the present disclosure. Furthermore, like reference numerals designate corresponding parts throughout the several views.

FIG. 1 is an exemplary vehicle safety system in accordance with an embodiment of the present disclosure.

FIG. 2 is a block diagram of the exemplary safety device of the vehicle safety system as shown in FIG. 1.

FIG. 3 is a flowchart depicting exemplary basic architecture and functionality of the vehicle safety system as shown in FIG. 1.

FIG. 4 is a flowchart depicting exemplary architecture and functionality of the vehicle safety system as shown in FIG. 1 using cameras and accident detection.

### DETAILED DESCRIPTION

A vehicle safety system of the present disclosure significantly reduces or eliminates the chance of a hot car death through its use inside of a vehicle. This portable device will not require any special installation tools and will receive its power from the vehicle itself. Installation may be as simple as plugging it into a cigarette lighter/accessory plug, the on-board diagnostics II (OBD2) assembly line diagnostics link (ALDL) port located under the dash or through any direct wired connection with an ignition switch activated power source (also known as “switched voltage”) within the vehicle. An integrated rechargeable battery will keep the device running after the vehicle supplied power has been shut down when the ignition switch is turned off by the driver or a “ignition off” signal is acquired at an assembly line diagnostics link (ALDL)/on-board diagnostics (OBD) connector in either a wired or wireless configuration.

The vehicle safety system comprises an automatic alert, which is activated once the device senses that the ignition of the vehicle has been turned off. This alert may be delivered even if additional passengers are not sensed by the circuit-based device inside of the vehicle. The nature of this alert may be auditory, shown on a display within the vehicle or delivered by electronic means (such as a text message or an app push notification) to a handheld device used by an owner and/or driver of the vehicle. A haptic physical sensation may also be delivered through a means that is tied to the circuit through either a wired or wireless configuration. After this initial alert is delivered, the secondary device function will then resume after a brief waiting period. The circuit will then monitor the cabin of the vehicle to determine if there are any passengers still present in the vehicle and if the internal temperature becomes too extreme (either hot or cold) to the point where it may endanger the occupant.

The third device function is having the ability to sense if someone has “re-entered” the vehicle while it is unattended. The vehicle safety system will provide additional protection against the reported 26.3% of deaths that resulted from children entering an empty vehicle alone and becoming trapped inside. In such cases, the vehicle owner will be the first to receive an alert (via a cellular message or app-based notification) regarding an occupant being inside their vehicle. If corrective action on the part of the vehicle owner does not take place after delivery of the alert, the vehicle safety system will contact either a third-party monitoring service or emergency services directly to provide information about the vehicle status and location.

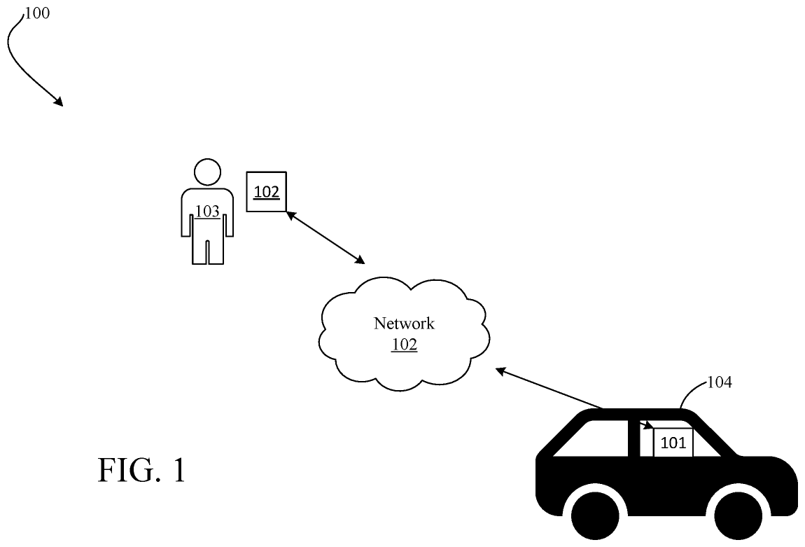

FIG. 1 is a vehicle safety system 100 in accordance with an embodiment of the present disclosure. The vehicle safety system 100 comprises cellular-equipped safety device 101 that is embedded in a vehicle 104. Note that the cellular-equipped safety device 101 shown in the window is for exemplary purposes only. As described herein, the cellular-based safety device 101 is inside the vehicle coupled to a power-providing implement.

The vehicle safety system 100 further comprises a handheld device 102, which can be, for example, a cellular phone. The owner/driver 103 of the vehicle 104 carries the handheld device 102.

The cellular-based safety device 101 communicatively couples to the handheld device 102. Thus, the owner and/or driver receives notifications and/or alerts from the cellular-equipped safety device 101.

The present disclosure provides an electronic battery and vehicle powered circuit in the cellular-equipped safety device 101 that is intended to significantly reduce or eliminate the chances of “hot car” deaths among children and animals inside of a vehicle. In this regard, the cellular-equipped safety device 101 provides alerts to either the operator and/or driver 103 of the vehicle 104 or any other third party that may be of assistance to those who remain in a vehicle in conditions that are potentially life threatening. There are three different situations when the cellular-equipped device 101 delivers alerts by audible, visual, or electronic means:

First, upon turning off the ignition of the vehicle 104, which cuts auxiliary charging power to the circuit of the cellular-equipped safety device 101 or from a signal indicating engine shut-off acquired through the ALDL connector. This alert delivers automatically to the handheld device 102 when the ignition turns off or in cases where switched power has been cut and has been sensed by the circuit of the cellular-equipped safety device 101 embedded in the vehicle 104. The alert may be audible, e.g., from the cellular-equipped safety device 101, visually on a display that is coupled to device 101, or through a haptic means, either wired or wirelessly.

Secondly, the cellular-equipped safety device 101 sends an alert to the handheld device 102 upon sensing that an occupant is still present in the vehicle after an amount of time has passed since the ignition switch turned off. This information augments with information that indicates when there is a notable measured change in interior temperature.

Thirdly, the cellular-equipped safety device 101 sends an alert upon sensing that an individual or animal has gained access to the unoccupied vehicle and the ignition switch is not turned on within a reasonably anticipated duration of time.

The on-board rechargeable battery and circuit board of the cellular-equipped safety device 101 is powered by the 12-volt system of the vehicle. This is accomplished by plugging it into one of the cigarette lighter/accessory ports, the ALDL “On Board Diagnostics” connector located under the dashboard or by directly wiring it to any switched 12-volt power source of the vehicle's wiring harness. Any time that the ignition switch is turned “off”, the device will sense a loss of charging power (also known as “switched voltage”) and the on-board rechargeable battery will continue to keep the circuit of the cellular-equipped safety device 101 operating.

When the ignition switch is turned off, the cellular-equipped safety device 101 will automatically deliver a message to the owner and/or driver 103 either directly or wirelessly via the handheld device 102 to remind the owner and/or the driver 103 not to leave any valuables or passengers in the vehicle unattended. The delivery of this message may be provided even if additional passengers are not sensed by the electronic device, depending on the preference of the vehicle operator. These alerts may be provided through any of the following means: (1) a speaker that is either integrated or tied to the device by wired or wireless means; (2) a display screen that is either integrated or tied to the device by wired or wireless means; (3) a text message delivered to their phone over a cellular, satellite or Wi-Fi network; (4) a push notification on their phone that is delivered through a companion app that the electronic device is registered to; or (5) haptic sensation that is delivered to the individual by a device that is tied to the electronic device through either wired or wireless means.

After the ignition switch of the vehicle 104 has been turned off and the initial reminder has been delivered, the cellular-equipped safety device 101 monitors for any indication that a passenger or animal is still present in the vehicle. This is determined by inputs provided to the circuit from a variety of potential sensors, which may include: (1) a microphone; (2) a motion sensor; (3) a video camera; (4) an infrared Sensor; (5) and accelerometer; (6) a seat weight sensor; or (7) radar or lidar.

The cellular-equipped safety device 101 monitors audio inputs to the microphone for specific patterns, such as the sound of a young child crying or a person calling for help. Further, the cellular-equipped safety device 101 receives a video camera input and discerns the difference between pets and humans. This distinction may be helpful in determining whether it is an individual or animal that is still present inside of the vehicle 104. Infrared sensors are used to identify the presence of life based upon the measurement of motion and observance of anticipated body temperatures of an occupant. An accelerometer is capable of sensing movements inside and around the vehicle that are based upon the opening/closing of doors and the shifting of body weight within the vehicle 104.

Seat weight sensors installed by the automobile manufacturer to deliver seat belt reminders or to adjust the airbag deployment methods of a vehicle may be used by the cellular-equipped safety device 101. The use of the existing weight sensors, or the addition of them as part of the installation of the vehicle safety system, may assist in making passenger determinations when the vehicle is not in operation. With such a heavy focus on automotive autonomy, both radar and lidar sensors have been developed which may provide information to determine the presence of an individual or animal in the confined space of a vehicle interior. Any of these sensors may be either integrated into the circuit device itself or externally providing it with data in either a wired or wireless configuration.

If the presence of life within the vehicle interior is determined after the ignition has been turned off for a prescribed amount of time, indicative of an individual or pet that was left in the vehicle unattended, a wireless alert is delivered to the vehicle owner's handheld device.

If this alert is not acknowledged or responded to by the recipient, a second wireless alert is delivered. If the vehicle owner is non-responsive to these two alerts, the cellular equipped device automatically contacts third-party monitoring or emergency services directly to report the vehicle location and other pertinent information to ensure that emergency assistance is promptly dispatched to aid the individual or animal that may be trapped inside of the vehicle.

If no interior activity in the vehicle 104 is sensed after the ignition switch has been turned off for some time after the owner and/or driver has exited the vehicle 104, the cellular-equipped safety device 101 will continue waiting until presence is once again measured that is the direct result of someone re-entering the vehicle. The accelerometer indicates such activity, as it can sense the movement activity related to a door being opened and the weight of an occupant being introduced into the vehicle cabin. If the entry is not easily discerned by the integrated accelerometer of the cellular-equipped safety device 101, a motion sensor, camera, microphone, infrared sensor or one of the other methods senses that an individual or animal has gained access to the vehicle cabin. Since a duration of time would have passed since the ignition was last turned off, the cellular-equipped safety device 101 will then wait for charging power to be restored to the cellular-equipped safety device 101 as a result of the ignition switch being turned back “on”. The presence of an individual without the ignition switch being turned on may also be used as an indicator that an unauthorized intruder with malicious intentions has entered the vehicle.

If the ignition switch has not been activated within a reasonable amount of time (delivering vehicle switched voltage to the circuit or an “ignition on” reading at the ALDL connector), an alert is sent via electronic means to the handheld device 102 of the vehicle owner and/or driver and any other defined recipient party. In cases where the temperature is measured to be outside of a prescribed safe range, the alert may also provide this information as well.

If corrective action does not take place within a brief waiting period, the cellular-equipped safety device 101 sends a second alert. Corrective action would be either a confirmation response from the message recipient (via text, app or other electronic means) or the action of the ignition switch being turned into the “on” position. At the discretion of the vehicle owner/operator 103, they may decide to report an intrusion as illegal activity, and the cellular-equipped safety device 101 may be instructed to report a break-in or a trapped individual to the appropriate emergency services for immediate attention. If the vehicle operator takes no action, the embedded cellular device will automatically contact either a third-party monitoring service or emergency services to report that an individual or animal has gained access into the unoccupied vehicle.

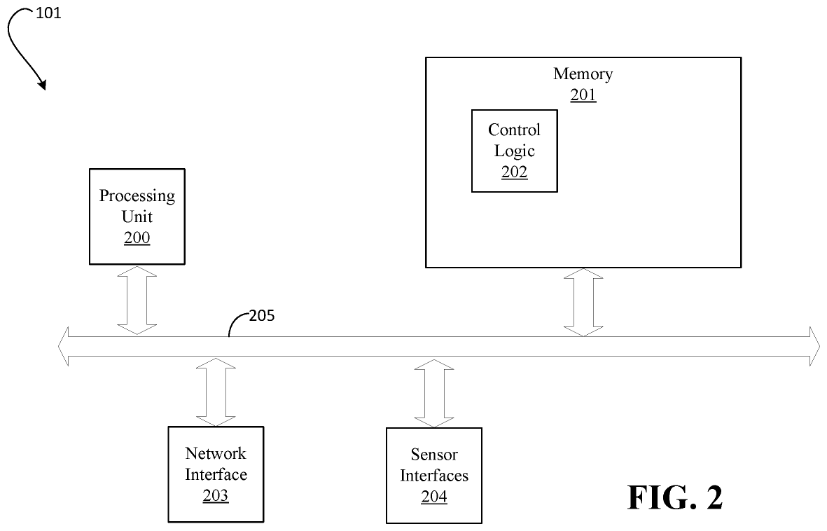

FIG. 2 depicts an exemplary embodiment of the cellular-equipped safety device 101 depicted in FIG. 1. As shown by FIG. 2, the cellular-equipped safety device 101 comprises a processing unit 200, a network interface 203, sensor interfaces 204, and memory 201. Stored in memory 201 is control logic 202 for receiving sensor inputs and transmitting alerts and/or notifications via the network interface 203.

The network interface 203 allows the cellular-equipped safety device 101 to communicate with the handheld device 102 and emergency monitoring services or first responders. Note that alerts and/or notifications are sent, for example, via a cellular network as well.

The exemplary embodiment of the cellular-equipped safety device 101 depicted by FIG. 2 comprises the at least one conventional processing unit 200, such as a Digital Signal Processor (DSP) or a Central Processing Unit (CPU), that communicates to and drives the other elements within the cellular-equipped safety device 101 via a local interface 205, which can include at least one bus. Further, the processing unit 200 is configured to execute instructions of software, such as the control logic 202.

The control logic 202 generally controls the functionality of the cellular-equipped safety device 101 that is embedded in the vehicle 104 (FIG. 1), as will be described in more detail hereafter. It should be noted that the control logic 202 can be implemented in software, hardware, firmware or any combination thereof. In an exemplary embodiment illustrated in FIG. 2, the control logic 202 is implemented in software and stored in memory 201.

Note that the control logic 202, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

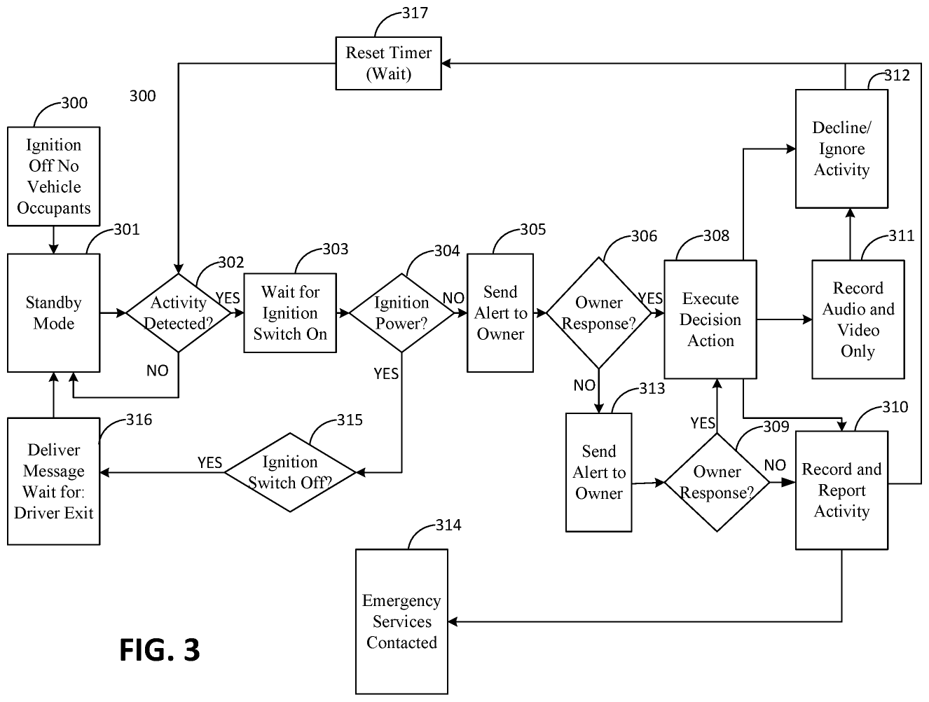

FIG. 3 is a flowchart of exemplary architecture and functionality of the cellular-equipped safety device 101 in accordance with an embodiment of the present disclosure.

In step 300, the control logic 202 (FIG. 2) of the cellular-equipped safety device 101 (FIG. 1) determines that the ignition is off and there are no vehicle occupants via the various sensors described above. As such, the control logic 202 enters standby mode in step 301.

If the control logic 202 detects activity via the various sensors described above in step 302, the control logic 202 waits for the ignition switch to turn on in step 303. The control logic 202 times the ignition switch activation. If the ignition receives power in step 304, the battery is charging. If the ignition switch is off in step 315, the control logic 202 delivers a message to the owner via the cellular equipped safety device 101 (FIG. 1) and/or the driver's handheld device 102 (FIG. 1) and waits for driver to exit in step 316. The control logic 202 times this activity and enters standby mode in step 301.

If in step 304 there is no power to the ignition, the control logic 202 sends an alert and/or notification to the handheld device 102 of the owner and/or driver 103 in step 305. This alert may be audible, visual, and/or haptic, as described above. If there is no owner response in step 306, the control logic 202 sends a second alert to the handheld device 102 of the owner and/or driver 103 in step 313.

If the owner and/or driver 103 does not respond to the second alert and/or notification in step 309, the control logic 202 records and reports the activity in step 310 and contacts emergency or monitoring services in step 314 via an app, text message, voice mail or other communications protocol utilizing the integrated cellular device.

If the owner does respond in step 309, the control logic 202 executes a decision action in step 308. In this regard, the control logic 202 declines or ignores the activity in step 312, records audio and video only in step 311 or records and reports the activity in step 310. The control logic 202 then resets the timer and waits in step 317.

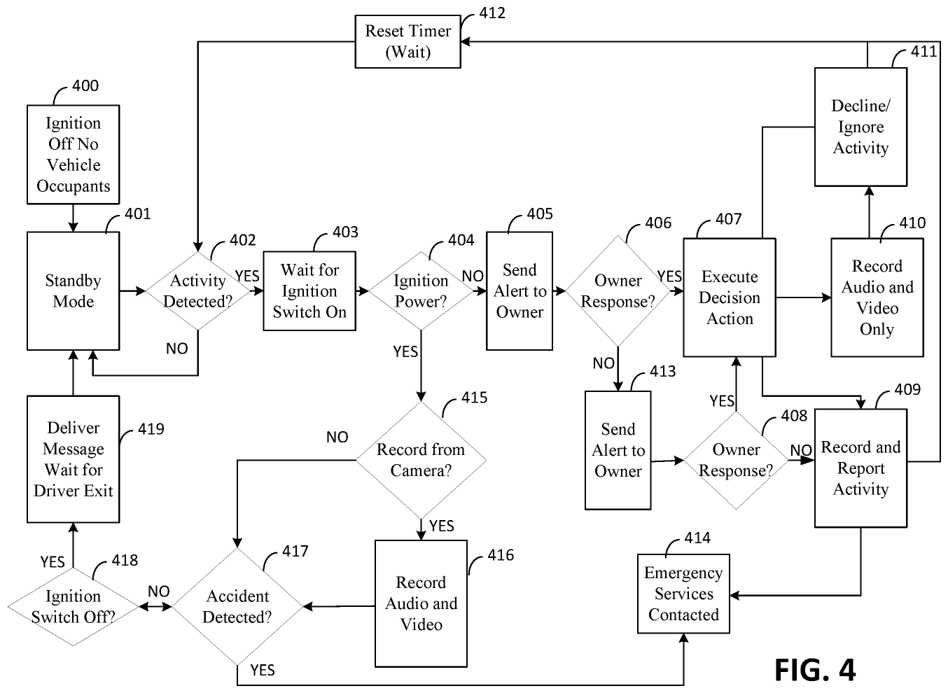

FIG. 4 is exemplary architecture and functionality of the vehicle safety system 100 in accordance with an embodiment of the present disclosure.

In step 400, the control logic 202 (FIG. 2) of the cellular-equipped safety device 101 (FIG. 1) determines that the ignition is off and there are no vehicle occupants via the various sensors described above. As such, the control logic 202 enters standby mode in step 401.

If the control logic 202 detects activity via the various sensors described above in step 402, the control logic 202 waits for the ignition switch to turn on in step 404. The control logic 202 times the ignition switch activation. If the ignition receives power in step 404, the battery is charging. In step 404, if the ignition switch receives power, the control logic 202 determines whether to record from the camera based upon the preference of vehicle operator 103 (FIG. 1) in step 415. If yes, the control logic records audio and video in step 416.

If an accident if detected in step 417, the control logic 202 contacts emergency services in step 414. Otherwise, if no accident if detected in step 417, the control logic determines if the ignition switch is off in step 418. If is off, the control logic delivers a message to the vehicle operator 103 (FIG. 1) via the cellular equipped safety device 101 (FIG. 1) or through wireless communications with the handheld device 102 (FIG. 1) of the owner and/or driver in step 419 and waits for the owner and/or driver to exit. The message may be audible, visual, and/or haptic, as described above. The control logic 202 then returns to standby mode in step 401.

If in step 404 there is no power to the ignition, the control logic 202 sends an alert and/or notification to the handheld device 102 of the owner and/or driver 103 in step 405. If there is no owner response in step 406, the control logic 202 sends a second response to the handheld device 102 of the owner and/or driver 103 in step 413.

If the owner and/or driver 103 does not respond to the second alert and/or notification in step 408, the control logic 202 records and reports the activity in step 409 and contacts emergency services in step 414 via an app, text message, voice mail or other communications protocol utilizing the integrated cellular device.

If the owner does respond in step 408, the control logic 202 executes a decision action in step 407. In this regard, the control logic 202 declines or ignores the activity in step 411, records audio, and video only in step 410 or records and reports the activity in step 409. The control logic 202 then resets the timer and waits in step 412.

1. A vehicle safety system, comprising:
a handheld device;
a processor configured for automatically delivering a message to an operator of a vehicle either directly or via the handheld device, through audible, visual, electronic or haptic means, to remind them that they should not leave a passenger or a valuable item unattended in the vehicle when the processor senses that the ignition switch of the vehicle has been turned off, either by a signal acquired at an assembly line diagnostics link (ALDL)/on-board diagnostics (OBD) connector in either a wired or wireless configuration or from a loss of switched power to the processor which results from turning off the ignition.

2. The vehicle safety system of claim 1, wherein the processor is configured to read at least one sensor to confirm a presence of passengers in the vehicle when the ignition switch is turned off.

3. The vehicle safety system of claim 2, wherein the sensor used to confirm the presence of the passenger is a microphone.

4. The vehicle safety system of claim 2, wherein the sensor used to confirm the presence of the passenger is a motion sensor.

5. The vehicle safety system of claim 2, wherein the sensor used to confirm the presence of the passenger is a video camera.

6. The vehicle safety system of claim 2, wherein the sensor used to confirm the presence of the passenger is an infrared sensor.

7. The vehicle safety system of claim 2, wherein the sensor used to confirm the presence of the passenger is an accelerometer.

8. The vehicle safety system of claim 2, wherein the sensor used to confirm the presence of the passenger is a seat-based weight sensor.

9. The vehicle safety system of claim 2, wherein the sensor used to confirm the presence of the passenger is a radar or lidar-emitting device.

10. A vehicle safety system, comprising:
a handheld device;
a processor configured for monitoring an interior of an automobile for any evidence that an occupant is present for any length of time after the vehicle ignition has been turned off, the processor further configured to transmit an alert to the handheld device when the occupant, a human or an animal presence is detected and the interior temperature is at a level that is unsafe for the occupant, and the alert is sent to the vehicle owner audibly, visually or electronically via cellular, wi-fi or internet-based communications, wherein when the recipient is not responsive and the individual remains in the vehicle, the processor will use a cellular or other wireless connection to contact emergency services either directly or through a third-party monitoring service to escalate the response to the threat posed against the individual or the animal in the vehicle.

11. The vehicle safety system of claim 10, further comprising at least one sensor for detecting the presence of the human or the animal.

12. The vehicle safety system of claim 11, wherein the sensor used to confirm the presence of the passenger is a microphone.

13. The vehicle safety system of claim 11, wherein the sensor used to confirm the presence of the passenger is a motion sensor.

14. The vehicle safety system of claim 11, wherein the sensor used to confirm the presence of the passenger is a video camera.

15. The vehicle safety system of claim 11, wherein the sensor used to confirm the presence of the passenger is an infrared sensor

16. The vehicle safety system of claim 11, wherein the sensor used to confirm the presence of the passenger is an accelerometer.

17. The vehicle safety system of claim 11, wherein the sensor used to confirm the presence of the passenger is a seat-based weight sensor.

18. The vehicle safety system of claim 11, wherein the sensor used to confirm the presence of the passenger is a radar or lidar-emitting device.

19. A vehicle safety system, comprising:
A handheld device;
a processor configured for monitoring and identifying when an individual enters an unoccupied vehicle without the operator present and the ignition is not turned on within a reasonable duration of time, the processor further configured for recording the vehicle interior temperature and transmitting an alert to the handheld device of an owner and/or driver audibly, visually or electronically via cellular, wi-fi or internet-based communications, the processor further configured for contacting emergency services either directly or through a third-party monitoring service to escalate the response to the threat posed by or against the individual or animal in the vehicle when the owner and/or driver is not responsive and for obtaining images inside the vehicle via a camera and sound inside the vehicle via a microphone, the processor further configured for using a cellular or other wireless connection to contact the owner and/or the driver.

20. The vehicle safety system of claim 19, wherein the processor is configured to receive input from at least one sensor.

21. The vehicle safety system of claim 20, wherein the sensor used to confirm the presence of the individual is a microphone.

22. The vehicle safety system of claim 20, wherein the sensor used to confirm the presence of the individual is a motion sensor.

23. The vehicle safety system of claim 20, wherein the sensor used to confirm the presence of the individual is a video camera.

24. The vehicle safety system of claim 20, wherein the sensor used to confirm the presence of the individual is an infrared sensor.

25. The vehicle safety system of claim 20, wherein the sensor used to confirm the presence of the individual is an accelerometer.

26. The vehicle safety system of claim 20, wherein the sensor used to confirm the presence of the individual is a seat-based weight sensor.

27. The vehicle safety system of claim 20, wherein the sensor used to confirm the presence of the individual is a radar or lidar-emitting device.

28. The vehicle safety system of claim 20, wherein the processor may be used by the vehicle owner to alert emergency services or third-party monitoring that a malicious break-in has occurred within the vehicle.
